(19) United States
(12) Patent Application Publication
(10) Pub. No.: US 2026/0128312 A1
(43) Pub. Date: May 7, 2026

(54) PROCESSING AID FOR FREESTANDING ELECTRODE FABRICATION

(71) Applicant: ARKEMA INC., KING OF PRUSSIA, PA (US)

(72) Inventors: AYDA RAFIE, KING OF PRUSSIA, PA (US); RAMIN AMIN-SANAYEI, KING OF PRUSSIA, PA (US); KOUAKOU DESSALESSE AMANI, KING OF PRUSSIA, PA (US); ROBERT J. BARSOTTI, KING OF PRUSSIA, PA (US)

(21) Appl. No.: 19/434,332

(22) Filed: Dec. 29, 2025

Related U.S. Application Data
(63) Continuation of application No. PCT/US2025/047890, filed on Sep. 25, 2025.
(60) Provisional application No. 63/698,661, filed on Sep. 25, 2024.

(51) Int. Cl. H01M 4/62; H01M 4/02; H01M 4/13; H01M 4/139

(52) U.S. Cl. CPC H01M 4/62; H01M 4/13; H01M 4/139; H01M 4/623; H01M 4/625; H01M 2004/021; H01M 2004/028

(57) ABSTRACT

This invention discloses a cathode film comprising: a graphite based processing aid, cathode active material, optionally a conductive carbon, and a fluoropolymer binder comprising PVDF and PTFE. The cathode film is free of residue solvent. The cathode film is made by a dry fabrication process.

### CROSS-REFERENCES TO RELATED APPLICATIONS

This application is a continuation of PCT/US2025/047890 which claims priority to U.S. 63/698,661, which are herein incorporated by reference.

### STATEMENT REGARDING FEDERALLY SPONSORED RESEARCH OR DEVELOPMENT

This application was made with United States Government support under DE-EE0009109 awarded by the Department of Energy of the United States. The United States Government has certain rights in the invention.

### FIELD OF THE INVENTION

The present invention relates generally to the field of energy storage devices. More particularly, the present invention relates to structures and methods for making dry binders and films for energy storage devices.

### BACKGROUND OF THE INVENTION

The processing rate of electrodes is often much lower than that of solution cast process due to concerns with the electrode's quality as well as the desire to reduce any irregularities in the fabricated electrodes. The irregularities in an electrode can be generally classified into two groups: 1) surface irregularities or defects due to lack of uniform dispersion of binder(s) and/or active materials and 2) gross irregularities which occurs due to uneven material flow or lack of sufficient malleability during the calendering step. The first one should be addressed during the powder mixing which is controlled by the PVDF type, PVDF particle size, as well as the use of processing aid(s) in the formulation. The second one occurs mostly during the calendering of electrode where the presence of processing aid allows the electrode to be rolled into uniform thin sheets without breaking, which in turn allows fabrication of high-quality, uniform and irregularity-free electrodes.

A proper processing aid should allow for faster processing rate by inducing malleability, reducing energy costs, and minimizing the occurrence of irregularities, hence reducing off-spec electrodes. However, many common processing aids are not compatible with the battery environment. On some occasions, PVDF powder has been used in the formulation of electrodes to improve its adhesion to the current collector. PVDF could also help with the PTFE particle dispersion within the electrode mixture prior to calendaring, however, it requires PVDF particle size to be in the nano size range, preferably less than 200 nm, to become an effective processing aid in making a uniform binder(s) dispersion during fabrication of the electrodes including cathode and anode.

PVDF-based polymers are semi-crystalline polymers used for many different applications such as extrusion, injection molding, fiber spinning, extrusion blow molding, blown film, and scaffolds to form articles. PVDF scaffolds are generally made via electrospinning of polymer solutions which often requires using toxic and flammable solvents. Fabricating scaffolds without using any solvent/liquid is advantageous especially when they are free of any residual solvent. Tensile strength and flexibility of articles made using scaffolds are important parameters for the purpose of handling, processing, and durability. The tensile strength of the articles made using scaffolds depends on the strength and quality of the scaffold, for example, electrode tensile strength, thickness, flexibility and mechanical properties are important to ensure that the roll-to-roll process is feasible. The volume resistivity of the electrodes is also an important parameter where the resistance inside the cell is directly correlated to the electronic conductivity within the electrodes. As a result, an electrode having low resistivity exhibits improved power density, energy density, and longevity.

The first cycle efficiency (FCE) in lithium-ion batteries (LIBs) and in Sodium-ion batteries (NIBs) refers to the percentage of charge that can be stored and then retrieved during the initial charging and discharging cycle. The FCE is an important parameter because the overall performance, especially cell capacity and longevity can significantly improve with FCE. Therefore, having a high FCE is very desirable.

Surprisingly, it was found that adding graphite/graphite-based processing aids to the cathode formulation can ease processing and allowed fabrication of high-quality, high strength cathodes. In some embodiments, conductivity and quality of electrodes can be further improved by using PVDF having a primary particle size of less than 150 nm. The cathode can be freestanding or supported.

DOI: 10.1002/ente.202200732 describes a solvent-free graphite anode using a PTFE and PVDF binder. Adding PVDF increased the first cycle efficiency and helped the integrity of electrode even after PTFE was electrochemically reduced and degraded in the first lithiation cycle. This article demonstrates that the free-standing electrode film was formed when the dry mixture was hot rolled at 160° C. The hot roll was needed because the described process failed to produce PVDF-PTFE scaffolds and consequently needed high temperature to melt or soften the PVDF and form freestanding electrodes. Freestanding electrodes made via melting PVDF are lacking flexibility due to high PVDF crystallinity. For roll-to-roll processes of freestanding electrodes, flexibility is an essential characteristic.

DOI: 10.1021/acsaem.2c03755 describes the impact of process and material parameters on the friction and shear behavior of a powder blend plays a key role for process optimization. Specifically, the mixture homogeneity of a powder blend significantly impacts bulk characteristics such as the internal friction of the powder. PVDF binder is used as a binder that can act as a lubricant during dry electrode manufacturing in a roll mill, shearing during the process was promoted and the processability window could be enhanced. Graphite is also used as a shearing aid during calendering. In addition, the binder used in this work is PVDF, which is different from the PVDF-PTFE binder of the invention.

U.S. Pat. No. 20240105955A1 describes A method of fabricating a cathode of an energy storage device, comprising: combining a portion of a porous carbon material and at least one component of a composite binder material to form a first mixture, wherein the at least one component comprises at least one of polyvinylidene fluoride (PVDF), a PVDF co-polymer, and poly(ethylene oxide) (PEO); subjecting the first mixture to a high shear process; and adding polytetrafluoroethylene (PTFE) to the first mixture after the subjecting step to form a second mixture. Porous carbons can exhibit low electronic conductivity, and that is not a desired ingredient for electrode fabrication.

U.S. Pat. No. US20190237748A1 describes a dry electrode film comprising active material, and dry binder, wherein the dry binder comprises at least one of polytetrafluoroethylene (PTFE), carboxymethylcellulose (CMC), and polyvinylidene fluoride (PVDF).

WO2024072861A2 describes a binder for lithium-ion secondary battery electrode, comprising dry friable agglomerates comprising i) a first polymer comprising a tetrafluoroethylene polymer having a melt creep viscosity of at least about 0.5×10¹¹ poise, and; ii) a second polymer different from said first polymer.

WO2024110976A1 describes a process of making an electrode using an active material, and a conductive additive optionally with a first binder to obtain a first mixture; blending a fibrillating binder with the first mixture, followed by high shear mixing to obtain a second mixture; and quenching the second mixture and calendering to obtain the electrode.

The addition of processing additives to the cathode forming compositions enhances the processing window and reduces irregularities of the cathode film. Once example of “enhancing the processing” is that less calendering passes are needed to obtain the desired thickness when the processing aid is present in the cathode formulation. The processing aid also helps to disperse the PVDF and PTFE uniformly. When the PVDF and PTFE is not uniformly distributed the performance is poor.

The processing aids for this invention comprise graphite-based processing aids. The process used in this invention is a dry method where all the component materials used are dry powder materials. No solvents are used in the method.

### BRIEF DESCRIPTION OF FIGURES

FIG. 1 is a picture of the functionalized PVDF (of example1) and PTFE alloy.

FIG. 2 is a SEM picture of the PVDF-PTFE scaffold material of example 5

FIG. 3 is a picture of a porous mat made with the functionalized PVDF and PTFE

FIG. 4 is a picture of film of example 14 after the mandrel test

FIG. 5 is a picture of Kynar 741-PTFE blend (example 20).

FIG. 6 is a SEM picture of Kynar 741-PTFE blend (example 20).

FIG. 7 is a picture of porous mats made with Kynar741-PTFE shows the porous mat made from example 21.

FIG. 8 is a picture of film of counter example 6 after the mandrel test

### SUMMARY OF THE INVENTION

This invention describes cathode films for energy storage devices and compositions of the cathode films that use a fluoropolymer binder and at least one processing aid. The electrodes are processed without any solvent/liquid and are free of any residual solvent. The electrode film of this invention is comprised of processing aid, PVDF and at least 0.1 wt % PTFE, and cathode active materials and optionally conductive carbon. The cathodes can be free standing or supported by a current collector or substrate.

In some embodiments the electrode film can be free standing or supported by a current collector or substrate.

The cathode film of this invention is made by a dry fabrication process.

In a preferred embodiment, the PVDF used to prepare the cathode composition, contains functional groups and preferably has a particle size less of than 150 nm, and more preferably less than 120 nm. The processing aid used to prepare the cathode film of this invention is a graphite-based material.

In some embodiments the processing aid has a number average particle size of less than 5 micron, preferably 4.5 microns or less, more preferably 4 microns or less. In other embodiments the processing aid can be greater than 5 microns. Average particle size is measured as the largest dimension of the particle using SEM (Scanning Electron Microscope).

In some embodiments of the invention, in addition to the processing aid, a binder which comprises a PVDF and PTFE blend, the PVDF comprises a functionalized PVDF, the blend appears as a single phase of material under SEM. The PVDF-PTFE blend may be in the form of a scaffold where the PVDF comprises a functionalized PVDF.

This invention discloses a cathode composition for fabricating cathodes for energy storage devices using PVDF-PTFE along with graphite-based processing aid(s). The cathodes are processed without any solvent/liquid and are free of any residual solvent. The cathodes of this invention comprise PVDF, PTFE, cathode active materials, and at least 0.1 wt % of graphite-based processing aid. The number average particle size of the processing aid of this invention is from 10 nanometers up to 20 microns (by SEM) depending on the formulation requirements. The cathode made by using the PVDF, PTFE and processing aid(s) of this invention exhibits higher tensile strength, higher electronic conductivity, ease of processing, and lower irregularities than those disclosed in the prior art.

The PVDF used in the invention preferably has a number average primary particle size between 50 to 300 nm for emulsion grade, and 2 to 200 μm for suspension grade PVDF.

### VARIOUS EMBODIMENTS OF THE INVENTION

A first embodiment of the invention provides a cathode film comprising: a processing aid, cathode active material, optionally a conductive carbon, and a fluoropolymer binder comprising PTFE, and wherein the cathode is free of solvent residue, and wherein the total binder amount is from 1 wt % to 10 wt % of the cathode film.

Embodiment 2: The cathode film may further comprise PVDF as a component of the binder wherein the weight ratio of PVDF to PTFE in the cathode is 10:90 to 95:5.

Embodiment 3: The cathode film of embodiment 1 or 2, wherein the processing aid has an ID/IG of less than 1.6.

Embodiment 4: The cathode film of any one or more of embodiments 1-3, wherein the processing aid has an ID/IG of less than 1.4.

Embodiment 5: The cathode film of any one or more of embodiments 1-4, wherein the processing aid is a graphite-based processing aid.

Embodiment 6: The cathode film of any one or more of embodiments 1-5, wherein the processing aid is selected from the group consisting of graphite powder, graphene, nano graphite, carbon nanotubes furnace black, acetylene black, carbon nanotubes (CNT), carbon nanofibers (CNF), fine graphite powder, vapor deposited graphite fibers, Ketjen carbon black and combinations thereof.

Embodiment 7: The cathode film of any one or more of embodiments 1-6, wherein the processing aid has a number average particle size of less than 5 microns.

Embodiment 8: The cathode film of any one or more of embodiments 1-5, wherein the processing aid is a flaked synthetic graphite having a number average particle size of less than 4.0 micrometers.

Embodiment 9: The cathode film of any one or more of embodiments 1-8, wherein the amount of processing aid is from 0.1 to 20 wt % based on the weight of the cathode film.

Embodiment 10: The cathode film of any one or more of embodiments 1-9, wherein the amount of processing aid is from 0.5 to 5 wt % based on the weight of the cathode film.

Embodiment 11: The cathode film of any one or more of embodiments 2-10, wherein the PVDF is a homopolymer or vinylidene fluoride copolymer.

Embodiment 12: The cathode film of any one or more of embodiments 2-11, wherein the PVDF is a vinylidene fluoride copolymer comprising at least 50 mole percent of vinylidene fluoride copolymerized with at least one comonomer.

Embodiment 13: The electrode of any one or more of embodiments 2-12, wherein the PVDF is a functionalized PVDF.

Embodiment 14: The cathode film of embodiment any one or more of embodiments 2-13, wherein the weight ratio of PVDF to PTFE is from 25:75 to 90:10.

Embodiment 15: The cathode film of embodiment 13, wherein the functional group comprises a carboxylic group or salt or ester thereof.

Embodiment 16: The cathode film of embodiment 13, wherein the functional group comprises a phosphate or sulfonate.

Embodiment 17: The cathode film of any one or more of embodiments 13-16, wherein the amount of functional groups is at least 0.1 mole percent to 10 mole percent, preferably 0.2 to 5 mole percent based on VDF monomer units.

Embodiment 18: The cathode film of any one or more of embodiments 2-17, wherein fluoropolymer binder comprising the PTFE and the functionalized PVDF is in the form of a scaffold.

Embodiment 19: The cathode film of any one or more of embodiments 1-18, wherein the cathode film is free standing.

Embodiment 20: The cathode film of any one or more of embodiments 1-18, wherein the cathode active material is selected from LiFePO₄, LiMnPO₄, LiFexMn_{y}PO₄, LiFePO₄F, LiMnPO₄F and LiFexMn_{y}PO₄F where x+y=1.

Embodiment 21: The cathode of any one or more of embodiments 1-18, wherein the cathode active material comprises at least one of lithium nickel manganese cobalt oxide (NMC), lithium manganese oxide (LMO), lithium iron phosphate (LFP), lithium cobalt oxide (LCO), and/or lithium nickel cobalt aluminum oxide (NCA), Lithium Manganese Iron Phosphate (LMFP), sulfur/Li₂S, or sulfur composites, sodium-based layered transition metal oxide such as chemical formula NaₓMO₂ (M=transition metal), such as Na₂/3Fe₁/3Mn₂/3O₂, NaFe_{0.4}Mn_{0.3}Ni_{0.3}O₂, α-NaFeO₂, and NaFeₓ(Mn_{0.5}Ni_{0.5})₁₋ₓO₂, polyanionic compounds such as Na₃M₂(PO₄)2F₃ (M=Ti, V, or Fe), Na₂MPO₄F (M=Fe or Mn), or NaM₃(PO₄)2P₂O₇(M=Ni, Co, or Mn); and combinations thereof.

Embodiment 22: The cathode film of any one or more of embodiments 1-21, wherein the cathode comprises 1 weight % to 6 weight % of the fluoropolymer binder based on weight of the cathode film.

Embodiment 23: The cathode film of any one or more of embodiments 1-22, wherein the cathode contains conductive carbon.

Embodiment 24: An energy storage device comprising the cathode film of any one or more of embodiments 1-23, wherein the energy storage device comprises a lithium-ion battery.

Embodiment 25: An energy storage device comprising the cathode film of any one or more of embodiments 1-23, wherein the energy storage device comprises a sodium-ion battery.

Embodiment 26: An energy storage device comprising the cathode film of any one or more of embodiments 1-23, wherein the energy storage device comprises a lithium sulfur battery.

Embodiment 27: A method of fabricating a cathode film of an energy storage device, comprising:
combining a processing aid, cathode active material, optionally conductive carbon, and PVDF to form a first mixture, adding PTFE to the first mixture to form a second mixture; and subjecting the second mixture to a shearing process to form a dry cathode forming mixture comprising PVDF and PTFE; wherein no liquid is used in the process.

Embodiment 28: The method of embodiment 27, wherein the processing aid is selected from the group consisting of graphite powder, graphene, nano graphite, carbon nanotubes furnace black, acetylene black, carbon nanotubes (CNT), carbon nanofibers (CNF), fine graphite powder, vapor deposited graphite fibers, Ketjen carbon black and combinations thereof.

Embodiment 29: The method of claim 27, wherein the processing aid has a number average particle size of less than 4.0 micrometers.

Embodiment 30: The method of claim 27, wherein the processing aid is a flaked graphite having a number average particle size of less than 4.0 micrometers.

Embodiment 31: The method of any one or more of embodiments 26-30, wherein the amount of processing aid is from 0.1 to 20 wt % based on the weight of the anode film.

Embodiment 32: The method of any one or more of embodiments 26-30, wherein the amount of processing aid is from 0.5 to 5 wt % based on the weight of the anode film.

Embodiment 33: The method of any one or more of embodiments 26-32, wherein each of the combining and the adding steps comprises blending at a temperature of 10° C. to 120° C.

Embodiment 34: The method of any one or more of embodiments 26-33, wherein the shearing comprises jet-milling.

Embodiment 35: The method of any one or more of embodiments 26-33, wherein the shearing comprises ball-milling and uses milling media.

Embodiment 36: The method of any one or more of embodiments 26-35, wherein combining further comprises combining a conductive carbon with the active material and the PVDF to form the first mixture.

Embodiment 37: The method of any one or more of embodiments 26-36, wherein the PVDF comprises a functionalized PVDF.

Embodiment 38: The method of any one or more of embodiments 26-37, wherein the PVDF comprises a PVDF copolymer.

Embodiment 39: The method of any one or more of embodiments 26-38, further comprising calendering the cathode film mixture to form a cathode film.

Embodiment 40: The method of embodiment 39, further comprising disposing the cathode film over a current collector to form an electrode.

Embodiment 41: The method of embodiment 40, wherein the disposing comprises laminating the cathode film to the current collector.

Embodiment 42: The method of any one or more of embodiments 26-41, wherein a mass ratio of the PVDF to PTFE is 10:90 to 95:5.

### DETAILED DESCRIPTION OF THE INVENTION

The references cited in this application are incorporated herein by reference.

Percentages, as used herein are weight percentages (wt %), unless noted otherwise, amounts in “ppm” are weight by weight based.

The term “fluoropolymer” refers to polymers and copolymers (including polymers having two or more different monomers, including for example terpolymers) containing at least 50 mole percent of fluoromonomer units. The copolymers may be homogeneous, heterogeneous, or random, and may have a gradient distribution of co-monomer units.

“Copolymer” is used to mean a polymer having two or more different monomer units, including terpolymers and higher degree polymers. “Polymer” is used to mean both homopolymer and copolymers.

“PVDF” means polyvinylidene fluoride, this includes both homopolymer and copolymers unless otherwise noted. “VDF” means vinylidene fluoride.

Dispersion means a dispersion or suspension of polymer particles in water. No oil phase or other organic phase is present.

Solids content means the matter that remains after drying of the dispersion. The solids content of the aqueous dispersion was measured by means of gravimetry method using a HG63 moisture analyzer from Mettler Toledo. A known quantity of the latex is dried and the change in weight is measured. A known weight of the latex (Q) is dried and the change in weight is measured (D). % Solids=[(Q−D)/Q]*100.

Melt viscosity are measured according to ASTM D3835 by a capillary rheometry at 230° C., and at shear rate of 100 sec⁻¹.

Thermogravimetric Analysis (TGA) is used to measure the 5% weight decomposition temperature. TGA was carried out from room temperature to 800° C. at a heating rate of 20° C./min under steady state flow of nitrogen.

Number Average particle size can be determined using scanning electron microscope (“SEM”). Particle size is reported as the largest dimension of the particle using SEM (Scanning Electron Microscope).

The infrared spectra were obtained using a Fourier transform infrared (FTIR) spectrometer (Nicolet iS50, Thermo-Fisher Scientific), equipped with a Thunderdome Diamond ATR accessory. The spectra were collected with a resolution of 4 cm⁻¹ with 32 scans per spectrum. For the analysis, the regions 837-840 cm⁻¹ (CH₂ and CF₂ vibrations) as containing a high contribution from non-α and 763-765 cm⁻¹ (CF₂ and CCC vibrations) as containing mainly a contributions are selected. For each spectrum, the maximum peak height (the highest peak within the respective range) are determined (the two selected regions) and a ratio is calculated.

The ultimate tensile strength (tensile at break, psi) and through plane resistivity of the films were measured using an Instron 3343 series. The tensile bar was a dog bone, as described in ASTM D1708. The speed used for this experiment was 12.7 mm/min. The samples were processed at room temperature and the ultimate tensile strength was measured in a controlled environment, where the dew point was kept at −5° C. The samples were not conditioned before the ultimate tensile test.

For through-plane resistivity, the sample was punched to 1″ diameter circles and was placed between two gold plated sheets. The resistance between the two plates, at different applied force, is measured using a Yoogawa resistance meter.

PVDF exhibits three main crystalline phases (α, β, and γ). As a result, PVDF can have various characteristics (solution viscosity, Tm, Tc and etc.) depending on the crystalline structure and ratio of crystalline phases. Changing the PVDF crystalline phase induces unique properties. For example, β phase induces piezoelectric, and pyroelectric properties. Also changing the PVDF crystalline phase from α to non-α, could improve adhesion properties of this semicrystalline polymer when used as a binder for battery electrodes. In some embodiments of the invention, the percentage of non-α phase of functionalized PVDF is higher than 70% after shearing with PTFE. The percentage of non-α phase increases by shearing PVDF with PTFE. Even after shearing with PTFE, the non-α phase is preferably higher than 70% for the functionalized PVDF. In contrast for non-functionalized PVDF we find non-α phase to be lower than 70% even after being blended with PTFE. Percent of crystalline phases are determined using FTIR spectra.

Scaffold means a 3-dimensional porous fibrous web structure or matrix formed by the polymer alloy when they are fibrillized by shearing. The scaffold appears as a fibrous web under SEM.

Polymers and polymer alloys capable of fibrillization are commonly referred to as “fibrillizable binders’ or “fibril-forming binders.” Fibril-forming binders find use with other powder like materials. Fibrillization of the binder particles produces fibrils that eventually allow formation of a matrix or lattice for supporting a resulting composition of matter. In the prior art, solvents, and/or other liquids, are added so that subsequent shear forces applied to a resulting mixture are sufficient to fibrillize the particles. The use of solvents is not desirable, especially if the solvents used are hazardous.

In some embodiments of the invention when the PTFE/PVDF mixture is subjected to shear the result is an alloy. In some embodiments the alloy is in the form of a scaffold. In the present invention, no solvents or liquids are used to create the alloy or the alloy in the form of a scaffold.

By alloy we mean a single-phase homogeneous physical blend of materials that exhibits a single-phase composition of PVDF-PTFE scaffolds according to SEM imaging.

The PTFE used in the present invention is expandable PTFE also called fibrillizable PTFE, meaning it can be expanded or fibrillized by stretching it in one or more directions, usually through shearing without melting. See for example U.S. Ser. No. 11/527,747 or U.S. Pat. No. 3,962,153.

The invention provides a composition comprising a processing aid, cathode active material and a binder comprising PVDF and PTFE.

The invention provides an article comprising the inventive composition.

The invention provides a cathode film comprising a processing aid, cathode active material and a binder comprising PVDF and PTFE.

In some embodiments the invention provides a cathode film comprising a processing aid, cathode active material and PTFE and a PVDF where the PVDF comprises a functionalized PVDF. The PTFE and a functionalized PVDF may be in the form of a scaffold.

The invention provides a method of making a cathode film comprising a processing aid, and a binder comprising a PVDF and PTFE.

The cathode film of this invention is free of solvent residuals.

### PVDF-Based Material

The term “vinylidene fluoride polymer” or “polyvinylidene fluoride” used herein includes homopolymers, copolymers, and functionalized polymers within its meaning. Such copolymers include those containing at least 50 mole percent of vinylidene fluoride, preferably greater than 65 mole percent or 90 mole percent or greater, copolymerized with at least one comonomer selected from the group consisting of tetrafluoroethylene (TFE), trifluoroethylene (TrFE), chlorotrifluoroethylene (CTFE), perfluorobutylethylene (PFBE), hexafluoropropene (HFP), vinyl fluoride (VF), pentafluoropropene, 2,3,3,3-tetrafluoropropene, trifluoropropene, fluorinated (alkyl) vinyl ethers, such as, perfluoroethyl vinyl ether (PEVE), and perfluoro-2-propoxypropyl vinyl ether, perfluoromethyl vinyl ether (PMVE), perfluoropropyl vinyl ether (PPVE), perfluorobutylvinyl ether (PBVE), longer chain perfluorinated vinyl ethers, one or more of partly or fully fluorinated alpha-olefins such as 3,3,3-trifluoro-1-propene, 2-trifluoromethyl-3,3,3-trifluoropropene, 1,2,3,3,3-pentafluoropropene, 3,3,3,4,4-pentafluoro-1-butene, hexafluoroisobutylene (HFIB), fluorinated dioxoles, such as perfluoro(1,3-dioxole) and perfluoro(2,2-dimethyl-1,3-dioxole) (PDD), partially- or per-fluorinated alpha olefins of C4 and higher, partially- or per-fluorinated cyclic alkenes of C3 and higher, partly fluorinated allylic, or fluorinated allylic monomers, and combinations thereof.

### Functionalized PVDF

In some embodiments a functionalized PVDF is used to make the cathode film.

Fluoropolymers, for example those based on vinylidene fluoride CF2=CH2 (VDF) or tetrafluoroethylene CF2=CF2 (TFE) are known to have excellent mechanical stability properties, very great chemical inertness, low surface energy, electrochemical stability, and good aging resistance. These qualities are exploited in various end-use applications.

Unfortunately, the excellent properties provided by fluoropolymers can also limit the applications in which they can be used. For example, it is difficult to bond fluoropolymers or combine them with other materials or alloy them with each other.

Some embodiments of the present invention use functionalized PVDF. By “functionalized” or “functional groups” we mean that groups containing at least one atom other than C, H or F are part of at least one monomeric unit of the fluoropolymer. Atoms, in addition to any one or more of C, H or F, in the functional groups include at least one of O, N, S, or P. Useful functional groups that can be incorporated into a fluoropolymer include, but are not limited to, carboxylic, hydroxyl, siloxane, ether, ester, sulfonic, phosphoric, phosphonic, sulfuric, amide, nitrile, epoxy groups, alkylene oxide (such as ethylene oxide or propylene oxide) or a mixture thereof. The carboxylic group includes the acid form, the salt form, the ester form, and anhydride form. In some embodiments the functional group contains an oxygen.

Carboxylic group includes the acid form, the salt form, the ester form and anhydride form.

Functionality (functional groups) may be incorporated into a fluoropolymer by different means, such as by copolymerization, post-polymerization grafting and use of low molecular weight functionalized polymer chain transfer agents.

Direct copolymerization of a monomer having a functional group (“functional monomer”) with the fluoromonomers can result in a functional fluoropolymer. Post-polymerization grafting mechanism, such as the grafting of maleic anhydride onto a polyvinylidene fluoride homopolymer or copolymer, as described in U.S. Pat. No. 7,241,817 can be used to functionalize a fluoropolymer. WO 2013/110740 and U.S. Pat. No. 7,351,498 further describe functionalization of a fluoropolymer by monomer grafting or by copolymerization.

Low molecular weight functionalized polymer chain transfer agents, as described in U.S. Pat. No. 11,643,484, can be used in the polymerization of fluoromonomers, as a means of both controlling the resulting fluoropolymer molecular weight and providing improved properties to the fluoropolymer. Useful functional chain transfer agents include, but are not limited to, polyacrylic acid, polylactic acid, polyphosphonic acid, polysulfonic acid, and polymaleic acid.

Functional monomers may include, but are not limited to, an acrylic based glycol ester, preferably the acrylic based glycol ester comprises at least one of polyethylene glycol acrylate (PEGA), polyethylene glycol methacrylate (PEGMA), polypropylene glycol acrylate (PPGA), or polypropylene glycol methacrylate (PPGMA).

Examples of functional monomers include, but not limited to, ethylenically unsaturated ionic monomer comprising at least one functional group selected from carboxylate, sulfonate, sulfate, phosphate, phosphonate, and/or acids, and/or salts, and/or anhydrides thereof.

Examples of acid functionalized monomers include ethylenically unsaturated monomers comprising at least one acid functional group. Examples of acid functionalized monomers include (meth) acrylic acid, beta-polycarboxy ethyl acrylate, 4-styrene sulfonic acid, 2-acrylamido-2-methylpropane sulfonic acid, vinyl phosphonic acid, vinyl sulfonic acid, mono-esters of itaconic acid, maleic acid, fumaric acid, and mixtures thereof.

Examples of functional monomers further include but are not limited to:
i) ethylenically unsaturated ionic monomer comprising at least one functional group; examples include (meth) acrylic acid, 2-carboxyethyl acrylate, 2-polycarboxy ethyl acrylate, mono-ester of itaconic acid, maleic acid, fumaric acid, crotonic acid, itaconic acid, 2-acrylamide-2-methylpropane sulfonic acid, 4-styrenesulfonic acid, vinylsulfonic acid, 2-sulfoethyl methacrylate, phosphate esters of polyalkylene glycol mono(meth)acrylate, polyalkylene glycol allyl ether phosphate, vinylphosphonic acid, 2-(methacryloyloxy)ethyl phosphonic acid; and/or acids, and/or salts, and/or anhydrides thereof; and mixtures thereof.
ii) oxyalkylated monomer with ethylenic unsaturation and terminated by a hydrogen or hydrophobic aryl or alkyl chain, having the following formula:

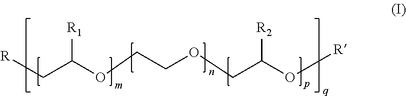

wherein: m and p represent a number of alkylene oxide units of from 0 and 15, n represents a number of ethylene oxide units of from 5 and 15, q represents a whole number at least equal to 1 or greater, R1 and R2 represent methyl or ethyl, and R′ represents a hydrogen or hydrophobic aryl chain with 5 to 60 carbon atoms or an alkyl chain end with 1 to 5 carbon atoms; R represents a group comprising at least one polymerizable olefinic unsaturation, preferably a group chosen from acrylate, methacrylate, acrylurethane, methacrylurethane, vinyl, allyl, methallyl, isoprenyl, an unsaturated urethane group, in particular acrylurethane, methacrylurethane, α-α′-dimethyl-isopropenyl-benzylurethane, allylurethane, more preferably a group chosen from acrylate, methacrylate, acrylurethane, methacrylurethane, vinyl, allyl, methallyl and isoprenyl, esters of maleic acid, esters of itaconic acid, esters of crotonic acid, even more preferably a methacrylate group, and mixtures thereof, and
iii) N-alkylol(meth)acrylamide, vinyl glycidyl ether, allyl glycidyl ether, glycidyl (meth)acrylate, diacetone acrylamide, acetoacetoxyethyl methacrylate, (meth)acryloxyalkyltrialkoxysilanes, vinyltrialkoxysilanes, and mixtures thereof.

The functionalized polyvinylidene fluoride comprises polymerized vinylidene fluoride units and preferably from 0.1 to 10 mole percent of functional groups in the polymer. The presence of functional monomer or functional group on the fluoropolymer can be detected by means of NMR.

The melt viscosity of the functionalized PVDF is at least 5 kPoise, preferably at least 10 kPoise, measured according to ASTM D3835 by a capillary rheometry at 230° C., and at shear rate of at 100 1/s.

### Cathode Active Material

The cathode active material comprises electrochemically active material in the form of a particulates. The cathode active materials are selected from conventional materials known in this field. The cathode electrochemically active materials include, but is not limited to, lithium nickel manganese cobalt oxide (NMC), lithium manganese oxide (LMO), lithium iron phosphate (LFP), lithium cobalt oxide (LCO), and/or lithium nickel cobalt aluminum oxide (NCA), Lithium Manganese Iron Phosphate (LMFP), sulfur/Li2S, or sulfur composites, sodium-based layered transition metal oxide such as general chemical formula NaₓMO₂ (M=transition metal), such as Na_{2/3}Fe_{1/3}Mn_{2/3}O₂, NaFe_{0.4}Mn_{0.3}Ni_{0.3}O₂, α-NaFeO₂, and NaFeₓ(Mn_{0.5}Ni_{0.5})₁₋ₓO₂ where 0<x≤1.0 preferably x being 0.2, 0.4, 0.6, 0.8 or 1.0, polyanionic compounds such as Na₃M₂(PO₄)₂F₃(M=Ti, V, or Fe), Na₂MPO₄F (M=Fe or Mn), and NaM₃(PO₄)₂P₂O₇ (M=Ni, Co, or Mn); layered compounds; sulfide including sodium; and fluoride including sodium, mixtures or combinations of the aforementioned materials, and/or other materials known in the art or described herein as suitable for use as the cathode in a lithium sulfur, lithium ion, and sodium ion batteries. These particulates may include active materials, i.e., materials capable of intercalating (accepting) lithium/sodium ions, and conductive materials. The cathode film may be used in a lithium/sodium-ion capacitor and/or a lithium/sodium-ion battery, or lithium sulfur battery. The electrode film can comprise from about 50 weight percent up to 98 wt %, preferably up to 97 wt %, preferably up to 96 wt %, of the cathode active materials. These cathode active materials are typically in the form of powders.

Cathode forming material means cathode active material plus processing aid plus binder plus any optional conductive carbon.

### Conductive Carbon

The conductive carbons are widely used in positive and negative electrodes to improve the electronic conductivity of electrodes. Examples of conductive carbon include but are not limited to, carbon black, onion like carbon, activated carbon. Conductive carbon and carbon black are essentially formed out of primary carbon particles which are spherical in shape and arranged into aggregates and agglomerates. These conductive carbons are used for enhancing electronic conductivity and therefore lower the charge transfer resistance of the cell. The typical loading level of the conductive carbon, when incorporated, relative to the cathode forming material in the cathode is usually within the range of 0 to 20% by weight, 0.1% by weight to 20% by weight, and more preferably within the range of 0.5% by weight to 10% by weight, based on the total amount of the particulate cathode-forming materials. These cathode forming materials are typically in the form of solid powders. “Cathode forming materials” means cathode active material and conductive carbon if used and processing aid and binder. In any case the total amount of all materials in the cathode film adds up to 100%.

### Graphite-Based Processing Aid

Conductive carbon such as Super-P and Denka-black are commonly used in positive and negative electrodes to decrease electronic resistivity within the electrode. However, graphite-based materials not only can improve electronic conductivity within the electrode, but also, they surprisingly enable fabrication of high conductivity and high-quality cathodes.

“Graphite” refers specifically to a crystalline form of carbon with a layered structure that makes it highly conductive due to its delocalized electrons. The graphite-based processing aid, such as the vapor grown carbon fibers (VGCFs), or vapor grown carbon nanofibers (VGCNFs), are cylindrical nanostructures with graphene layers arranged into cylinders. The Ketjen carbon black contains a network of disordered graphene-sheets stacks.

Flaked graphite refers to a form of graphite that has a flake-like morphology, which appears as flat, plate-like particles.

Non-limiting examples of graphite-based processing aids include graphite powder, graphene, graphene oxide, nano graphite, carbon nanotubes furnace black, acetylene black, carbon nanotubes (CNT), carbon nanofibers (CNF), fine graphite powder, vapor deposited graphite fibers, and Ketjen carbon black. Graphitizing carbons can be used as the graphite-based processing aids. Flaked graphite can be used as the graphite-based processing aid.

The typical loading level of the processing aid in cathode formulation can vary depending on the process and processing condition and usually is between 0.1% to 20% by weight, preferably within the range of 0.5% to 10% by weight, and more preferably is 0.5 to 5% based on the weight of the cathode forming materials.

Graphitizing carbons are soft and non-porous, while non-graphitizing carbons are hard, low-density materials. The degree of carbon ordering (graphitization) can be obtained from Raman spectroscopy. The D- and G-modes in the area of 1200-1700 cm⁻¹ appear for each sample at different positions and with different intensities depending on their structural features. The degree of carbon ordering (graphitization) can be obtained from the D- and G-mode FWHM (full-width at half-maximum) values and the intensity ratio ID/IG. A high ID/IG ratio together with low FWHM values indicate a high degree of structural order within the carbon. As an example, C-NERGY™ KS6L (Imerys) has a carbon ordering (ID/IG) of 0.2, whereas this ratio is 2.6 for Super P, indication of a very high graphitization for KS6L.

The processing aid of this invention has an ID/IG of less than 1.6, preferably less than 1.4. Above 2 is considered conductive carbon.

Some of the Graphite-based processing aids are composed of layers of carbon atoms that are arranged in 6-membered, hexagonal rings. In a graphite-based processing aid, each carbon atom is joined to three other carbon atoms by covalent bonds which in turn the carbon atoms form layers with a hexagonal arrangement of atoms. These rings are attached to one another on their edges. Layers of fused rings can be modeled as an infinite series of fused benzene rings (without the hydrogen atoms). The electrical conductivity perpendicular to the layers is consequently about 1000 times lower than that of on the planes. On the other hand, the conductive carbon, typically in the form of “carbon black,” is structured with small, primary carbon particles that are highly aggregated, forming a complex network of branched chains with many spaces between them, which allows for efficient electron transport and contributes to its electrical conductivity.

In some instances, the processing aid has a number average particle size (by SEM) of less than 7.0 micrometers. In some instances, the processing aid has a number average particle size of less than 5.0 micrometers. In some instances, the processing aid has a number average particle size of less than 4.0 micrometers.

### Ease of Processing:

In addition to process design, material selection plays an important role in powder flow, binder dispersion, shear behavior, flexibility of the film, and film processing. For powders, such as PVDF in powder form, addition of graphite based processing aids can widen the processing window by enabling the uniform dispersion of the powders, reducing the number of passes required for the film to reach the target thickness, and reducing the wear of forming tools. Without the use of a proper processing aid, reducing the film thickness becomes very challenging as the calendering of the film, resulting in over densification which has several consequences: a) low porosity of the film leading to an electrode that can significantly reduce ionic diffusion, b) active material cracking, resulting in cell instability, and c) problems in film handling or winding because of poor flexibility.

### Manufacture of Cathode Film

In some embodiments a PVDF-PTFE blend is made by combining PVDF in powder form and PTFE in powder form, and then shearing the blend at a temperature of between 10° C. and the melting temperature of the PVDF, preferably between 15° C. and 120° C. In some embodiments the PVDF is a homopolymer or copolymer (without functional groups) and in some embodiments the PVDF is functionalized PVDF. For example, the PVDF-PTFE blend can be made by mixing first at low shear followed by high-shear mixing until fibers are formed. For example, at a laboratory scale, the powder was first mixed at 500 rpm for 1 minute, with 2 zirconia beads, followed by shearing at 2000 rpm for 2 mins with total of 7 zirconia beads in a Thinky mixer resulting in PVDF-PTFE scaffolds, at ambient temperature.

High Shear mixing or blending is used to blend PVDF and the PTFE together. In some embodiments the blend has a scaffold structure. Batch mixers and in-line mixers can be used. At a laboratory scale, this was accomplished, by ball milling using mixing media. The bulk material is sheared to produce scaffolding in a high-energy ball mill using milling media like balls or beads. There is a variety of milling media materials such as: Steel (chrome steel, and stainless steel, 304SS and 316SS) or Ceramics (agate, alumina, yttria stabilized zirconia, zirconium silicate, zirconia toughened alumina, and tungsten carbide).

The method of fabricating a cathode of an energy storage devices comprises combining a processing aid, a cathode active material, optionally conductive carbon, and PVDF to form a first mixture, adding PTFE to the first mixture to form a second mixture; and subjecting the second mixture to a shearing process to form a dry cathode forming mixture. The process is a dry process. No liquid is used in the process. All components are in a powder form.

The processing aid can be any processing aid described above.

The cathode active material can be any cathode active material described herein.

In some embodiments the PVDF is a homopolymer or copolymer (without functional groups) and in some embodiments the PVDF is functionalized PVDF. The functionalized PVDF can be functionalized PVDF described herein.

The steps of the method can be performed a temperature of between 10° C. to 120° C.

The shearing can be done via jet-milling.

The shearing can be done via ball-milling and may use milling media.

The method may further comprises adding a conductive carbon with the active material and the PVDF.

The resulting material may be calendered to form a cathode film. The cathode film may be disposed over a current collector to form a cathode. This may be done by laminating the cathode film to the current collector.

### EXAMPLES

### Example 1 Production of PVDF with Particle Size Below 100 nm

To a 7.5-liter, stainless steel reactor was added 4200 g of water and 0.5 g of non-ionic emulsifiers of Pluronic® 31R1 (from BASF) and 3.5 g of Poly (Propylene Glycol) Monomethacrylate (“PPGMA”). The mixture was purged with nitrogen and agitated for 0.5 hours. The reactor temperature was raised to 105° C. for deoxygenation. The reactor sealed, while agitation was continued, the temperature was set at 100 C. The reactor was charged with vinylidene fluoride to a pressure of 650 psig (4.5 MPa); an aqueous initiator solution, comprised of 2 wt. % in potassium persulfate and 2 wt % in sodium triacetate, was charged at 500 g/hr to initiate the polymerization. The initiator solution feed rate was set at about 60 g/h to maintain the reaction throughout the rest of the polymerization. Total initiator was 300 milliliters. The reaction pressure was maintained at 650 psig by adding as needed vinylidene fluoride. After a total of 1500 g of VDF was added to the reactor, the monomer feed was stopped. For a period of 10 minutes, agitation was continued, and the temperature was maintained. The agitation and heating were discontinued. After cooling to room temperature, surplus gas was vented, and the reactor was emptied of dispersion through a stainless-steel mesh screen (208 micron). The PVDF latex has 29% solid contents. The PVDF powder has a melt viscosity of greater than 27 kPoise. The average primary particle size is 82 nm. Melting temperature was measured to be 164° C.

### Example 2 Production of PVDF/HFP Copolymer with Particle Size Below 100 nm

To a 7.5 liter stainless steel reactor was added 4200 g of water and 0.5 g of non-ionic emulsifiers of Pluronic® 31R1 (from BASF) and 3.5 g PPGMA. The mixture was purged with nitrogen and agitated for 0.5 hours. The reactor temperature was raised to 105° C. for deoxygenation. The reactor sealed, while agitation was continued, the temperature was set at 100° C. The reactor was charged with vinylidene fluoride to a pressure of 650 psig (4.5 MPa); an aqueous initiator solution, comprised of 2 wt. % in potassium persulfate and 2 wt % in sodium triacetate, was charged at 500 g/hr to start the polymerization. The initiator solution feed rate was set at about 60 g/h to maintain the reaction rate throughout the rest of the polymerization. Total initiator was 290 milliliters. The reaction pressure was maintained at 650 psig by adding as needed vinylidene fluoride. After a total of 365 g of VDF was added to the reactor, the VDF feed was stopped and 273 g of HFP monomer is added to reactor and then was topped with VDF to reach 1500 g total of VDF. For a period of 10 minutes, agitation was continued, and the temperature was maintained. Then agitation and heating were discontinued. After cooling to room temperature, surplus gas was vented, and the reactor was emptied of dispersion through a stainless-steel mesh screen (208 micron). The PVDF latex has 31% solid contents. The PVDF powder has a melt viscosity of 25 kPoise (at 100 1/s), a melting temperature of 162° C. and primary particle size of 87 nm.

### Example 3 Production of PVDF (with PPGMA and PAA) with Particle Size Below 100 nm

To a 7.5 liter, stainless steel reactor was added 3000 g of water and 0.5 g of non-ionic emulsifiers of Pluronic 31R1 (from BASF) and 3.0 g of PPGMA. The mixture was purged with nitrogen and agitated for 0.5 hours. The reactor temperature was raised to 105° C. for deoxygenation. The reactor sealed, while agitation was continued, the temperature was set at 100° C. The reactor was charged with vinylidene fluoride to a pressure of 650 psig (4.5 MPa); an aqueous initiator solution, comprised of 2 wt. % in potassium persulfate and 2 wt % in sodium triacetate, was charged at 500 g/hr to start the polymerization. Total initiator was 255 milliliters. The initiator solution feed rate was set at about 60 g/h to maintain the reaction rate throughout the rest of the polymerization. The reaction pressure was maintained at 650 psig by adding as needed vinylidene fluoride. After a total of 800 g of VDF was added to the reactor, a 5 wt % solution of polyacrylic acid (Sokalan CP-10 from BASF) having a weight average molecular weight of ˜4000 in water was fed to the reactor at 200 ml/hr while the feeding of VDF continued. Addition of polyacrylic acid solution was stopped when a total of 195 ml of PAA solution was reached. Addition of VDF was stopped when the total of VDF fed reached 1700 g. For a period of 10 minutes, agitation was continued, and the temperature was maintained. Then agitation and heating were discontinued. After cooling to room temperature, surplus gas was vented, and the reactor was emptied of dispersion through a stainless-steel mesh screen (208 micron). The PVDF latex has 33% solid contents. The PVDF powder has a melt viscosity of 28 kPoise (at 100 1/s), a melting temperature of 164° C. and a primary particle size of 95 nm.

### Example 4 Production of PVDF (PPGMA and PAM) with Particle Size Below 100 nm

To a 7.5 liter, stainless steel reactor was added 3000 g of water and 0.5 g of non-ionic emulsifiers of Pluronic 31R1 (from BASF) and 3.0 g of PPGMA. The mixture was purged with nitrogen and agitated for 0.5 hours. The reactor temperature was raised to 105° C. for deoxygenation. The reactor sealed, while agitation was continued, the temperature was set at a 100° C. The reactor was charged with vinylidene fluoride to a pressure of 650 psig (4.5 MPa); an aqueous initiator solution, comprised of 2 wt. % in potassium persulfate and 2 wt % in sodium triacetate, was charged at 500 g/hr to start the polymerization. Total initiator was 270 milliliters. The initiator solution feed rate was set at about 60 g/h to maintain the reaction rate throughout the rest of the polymerization. The reaction pressure was maintained at 650 psig by adding, as needed, vinylidene fluoride. After a total of 800 g of VDF was added to the reactor, 2% wt/wt of solution of alkyl methacrylate phosphate (Sipomer® PAM 4000 by Solvay) in water and then was fed to the reactor at 100 ml/hr while the feeding of VDF continued for a total of 285 ml of Sipomer® PAM 4000 solution. Addition of VDF and PAM 4000 solution were stop when the total of fed VDF reached 1700 g. For a period of 10 minutes, agitation was continued, and the temperature was maintained. The agitation and heating were discontinued. After cooling to room temperature, surplus gas was vented, and the reactor was emptied of dispersion through a stainless-steel mesh screen (208 micron). The PVDF latex has 28% solid contents. The PVDF powder has melt viscosity of 29 kPoise (at 100 1/s), a melting temperature of 161° C. and an average primary particle size of 78 nm.

### Example 5 Functionalized PVDF-PTFE Scaffold

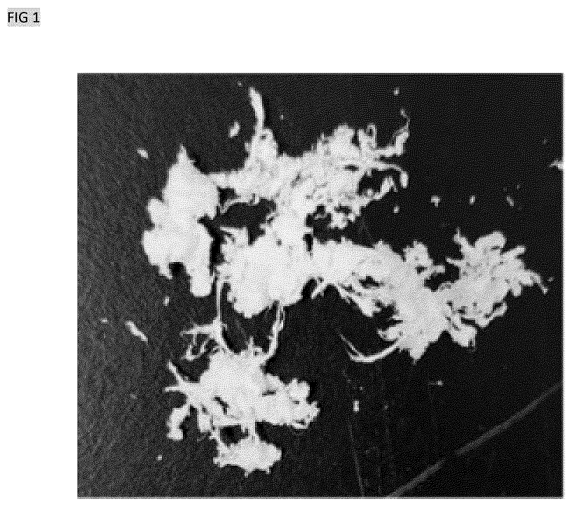

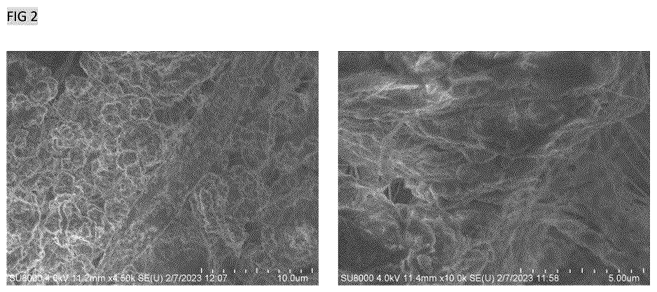

PVDF-PTFE scaffold was made by shearing 3 g of PVDF functionalized polyvinylidene fluoride fluoropolymer powder (functionalized with PPGMA) of example 1 and 1 g of PTFE powder (Teflon® PTFE 601X from Chemours) with total of 7 Zirconia beads of 6.5 mm, using a planetary mixer (Thinky ARE-310). The powder was first mixed at 500 rpm for 1 minute, with 2 zirconia beads, followed by shearing at 2000 rpm for 2 minutes with total of 7 zirconia beads resulting in formation of PVDF-PTFE scaffolds, FIG. 1. The PVDF-PTFE scaffolds of this example is a fibrous powdery material. FIG. 2 is a SEM of the PVDF-PTFE scaffold material of Example 5, based on the SEM pictures, no PVDF spherical particles are observed in the scaffold. This shows that the PVDF is physically alloyed with the PTFE to form the functionalized PVDF-PTFE scaffolds.

### Example 6 Making PVDF-PTFE Porous Mat

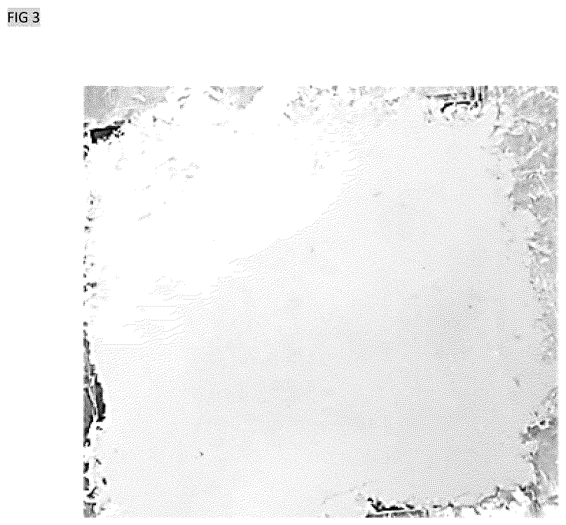

Functionalized PVDF from examples 1 and 4 each separately was combined with PTFE (PVDF/PTFE: 3/1 by weight) to produce scaffolds following this process. The samples were compression molded using a Carver Press and samples were pressed at six metric ton at room temperature for 10 minutes. The tensile bar has a thickness of ˜1000 μm. FIG. 3 shows a picture of the porous mat and confirms the uniform color of this article. This shows that the functionalized PVDF and the PTFE form a single phase. Ultimate tensile strength of these mats was measured according to the ASTM D1708 method and the ultimate tensile were corrected for porosities of these mats. The results are reported in Table 1. The porosity (∈) of the sample was measured based the measured density of the mat and calculated density of PVDF and PTFE using the following equation:

$$ϵ = 1 - \frac{measured density}{calculated density}$$

FIG. 3 shows the porous mat made from example 5. The material exhibits homogeneous color. As seen in the FIG. 3, the mat has an even color throughout the article, consistent with uniform distribution of PVDF-PTFE in the alloy.

### Example 7 FTIR of Functionalized PVDF and Alloy of Functionalized PVDF-PTFE

The FTIR spectra of PVDF of example 1 and 4, and porous mats of example 6 were measured and the amount of non-α phase PVDF is calculated. For the analysis, the regions 837-840 cm⁻¹ (CH₂ and CF₂ vibrations) as containing high contribution from non-α and 763-765 cm⁻¹ (CF₂ and CCC vibrations) as containing mainly a contributions are selected. For each spectrum, the peak heights are determined (the two selected regions) and a ratio is calculated (peak height at 840 divided by the sum of the two peak heights). The percentage of non-α phase is reported in Table 2.

### Example 8 TGA

Thermal degradation of functionalized PVDF of example 1 and 4, functionalized PVDF (Solef 5130, Synesqo), and alloy of functionalized PVDF-PTFE of example 6 were evaluated by TGA. The decomposition temperature at 5% weight loss is reported in Table 3. The decomposition temperature corresponds to 5% weight loss of the initial mass, when the decomposition starts.

### Example 9 Making Cathode Films

Cathode films were made by mixing NMC811 (Ronbay), functionalized PVDF of example 1 (functionalized with PPGMA), PTFE (601X, Chemours), and Super P (Imerys) in a weight ratio of 95:1.5:1.5:2:wt % in a Thinky mixer (ARE310). Total amount of powder used in this sample is 30 g. The Thinky cup was cooled down to 25-35° C., using a water-ice bath, after each mix at 2000 rpm. First PVDF and NMC811 were mixed at 2000 rpm for 2 minutes. Then Super P was added, and the sample was mixed at 2000 rpm for 2 minutes. After addition of PTFE, the mixture was mixed twice at 2000 rpm for 2 minutes. Zirconia beads were added to the mixture and the sample was sheared at 2000 rpm for 2 minutes. The shearing step was repeated three times. The material was turned into a film at room temperature. The ultimate tensile strength of these samples was measured using the ASTM D1708 method. The tensile bar was a dog bone, as described in ASTMD1708. The speed used for this experiment was 12.7 mm/min. The ultimate tensile strength was measured in a controlled environment, where the dew point was kept at −5° C. The samples were not conditioned before the tensile test. Through-plane resistivity of these samples were measured. For through-plane resistivity, the sample was punched to 1″ diameter circles and was placed between two gold plated sheets. The resistance between the two plates, at different applied force, is measured using a Yoogawa resistance meter. The ultimate tensile strength and resistivity of these samples are reported in Table 4.

### Example 10 Making Cathode Films

Cathode films were made by mixing NMC622 (Umicore), functionalized PVDF of example 1 (functionalized with PPGMA), PTFE (601X, Chemours), Super P (Imerys), and graphite (KS6L, Imerys) in a weight ratio of 94.5:1.5:1.5:2:0.5 wt % in a Thinky mixer (ARE310). Total amount of powder used in this sample is 30 g. The Thinky cup was cooled down to 25-35° C., using a water-ice bath, after each mix at 2000 rpm. First PVDF and NMC622 powders were mixed at 2000 rpm for 2 minutes. Then Super P was added, and the sample was mixed at 2000 rpm for 2 minutes. KS6L was added to this mixture and the mixture was mixed for 2 minutes at 2000 rpm. After addition of PTFE, the mixture was mixed four times at 2000 rpm for 2 minutes. Zirconia beads were added to the mixture and the sample was sheared at 2000 rpm for 2 minutes. The shearing step was repeated twice. The material was turned into a film at room temperature, and calendered, using a horizontal calender at 70° C. The tensile strength of these samples was measured using the ASTM D1708 method. The tensile bar was a dog bone, as described in ASTM D1708. The speed used for this experiment was 12.7 mm/min. The ultimate tensile strength was measured in a controlled environment, where the dew point was kept at −5° C. The samples were not conditioned before the tensile test. Through plane resistivity of these samples were measured. For through-plane resistivity, the sample was punched to 1″ diameter circles and was placed between two gold plated sheets. The resistance between the two plates, at different applied force, is measured using a Yoogawa resistance meter. The Ultimate tensile strength and resistivity of these samples are reported in Table 4.

### Example 11 Making Cathode

The cathode films of examples 9 and 10 were laminated on a carbon coated aluminum foil (Ensafe123, Armor) at 120° C. using a Hohsen roll mill. The electrode was dried to remove any residual moisture. A half-cell was made using this electrode. The cell is cycled between 2.8-4.3 V (vs Li/Li*) against lithium metal (thickness 250 μm). The electrolyte was 1 M LiPF₆ in EC/EMC with 5% FEC additive (all from Gotion) and a polyethylene separator (Celgard 2500) was used. Cycling results are presented in Table 5. In this table, Recovery at C/10 (SOH in %) is calculated by dividing C/10 capacity after rate capability (up to 2 C) to initial C/10 capacity after formation.

### Example 12 Evaluating the Quality of Film and Cohesion Between Particles

NMC811 films were made by mixing NMC811 active material (Ronbay), PTFE, functionalized PVDF of example 1, conductive carbon (Super P, Imerys), and graphite processing aid (KS6L, Imerys) in a weight ratio of 94.5, 1.5, 1.5, 2 and 0.5%. A Thinky mixer (ARE310) mixer was used. First PVDF and NMC811 were mixed at 2000 rpm for 2 minutes. Then Super P was added, and the mixture was mixed at 2000 rpm for 2 minutes. To the second mixture KS6L processing aid was added, and this mixture was also mixed at 2000 rpm for 2 minutes. PTFE was added, and the mixture was mixed at 2000 rpm for 2 minutes. The mixing was repeated four times. After that the sample was sheared with mixing media, 4 beads of 10 mm and 3 beads of 12 mm, for 2 minutes at 2000 rpm. The sample was then flipped and sheared for the second time at 2000 rpm for 2 minutes. To avoid melting the polyethylene Thinky jar, ice bath was used, and the jar was cooled to 25-35° C. after each mix. Total amount of powders used in this sample is 30 g. The malleable sample was then turned into the film at room temperature. A freestanding film was formed at room temperature. To evaluate the cohesion of the particles and quality of the scaffold, the amount of loose powder was measured using a scotch tape. A scotch tape (A=area in cm²), (weight=m₁) was placed on the film. After passing the tape with a roller, the weight of scotch tape was measured (m₂) for the second time. The change in weight of the scotch tape (m₂-m₁) represents the amount of loose powder. The change in weight for this sample was measured to be 8 mg/cm², calculated using the following equation:

$$\frac{{m}_{2} - {m}_{1}}{A}$$

### Example 13 Making NMC83 Films

NMC83 films were made by mixing NMC83 active material (Ronbay), PTFE, functionalized PVDF of example 1, conductive carbon (Super P, Imerys), and graphite processing aid (KS6L, Imerys) in a weight ratio of 94.5, 1.5, 1.5, 2 and 0.5%. A Thinky mixer (ARE310) mixer was used. First PVDF and NMC83 were mixed at 2000 rpm for 2 minutes. Then Super P was added, and the mixture was mixed at 2000 rpm for 2 minutes. To the second mixture KS6L processing aid was added, and this mixture was also mixed at 2000 rpm for 2 minutes. PTFE was added, and the mixture was mixed at 2000 rpm for 2 minutes. The mixing was repeated four times. After that the sample was sheared with mixing media, 4 beads of 10 mm and 3 beads of 12 mm, for 2 minutes at 2000 rpm. The sample was then flipped and sheared for the second time at 2000 rpm for 2 minutes. To avoid melting the polyethylene Thinky jar, ice bath was used, and the jar was cooled to 25-35° C. after each mix. Total amount of powders used in this sample is 30 g. The malleable sample was then turned into the film at room temperature. A freestanding film was formed at room temperature. This film was then calendered at 70° C. to the desired thickness. The ultimate tensile strength of these samples was measured using the ASTM D1708 method. The tensile bar was a dog bone, as described in ASTMD1708. The speed used for this experiment was 12.7 mm/min. The ultimate tensile strength was measured in a controlled environment, where the dew point was kept at −5° C. The samples were not conditioned before the tensile test. Through plane resistivity of these samples were measured. For through-plane resistivity, the sample was punched to 1″ diameter circles and was placed between two gold plated sheets. The resistance between the two plates, at different applied force, is measured using a Yoogawa resistance meter. The Ultimate tensile strength and resistivity of these samples are reported in Table 4.

### Example 14 Making LFP Films

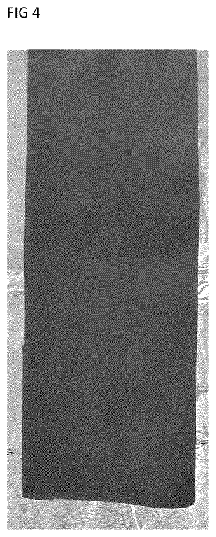

LFP films were made by mixing LFP active material (YN-7, Hunan Yuneng New Energy Battery Material Ltd.), PTFE (601X, Chemours), functionalized PVDF of example 1, and graphite processing aid (KS6L, Imerys) in a weight ratio of 93, 2, 2, and 3%. A Thinky mixer (ARE310) mixer was used. First PVDF and LFP were mixed at 2000 rpm for 2 minutes. Then, KS6L processing aid was added, and this mixture was also mixed at 2000 rpm for 2 minutes. PTFE was added, and the mixture was mixed at 2000 rpm for 2 minutes. The mixing was repeated four times. After that the sample was sheared with mixing media, 4 beads of 10 mm and 3 beads of 12 mm, for 2 minutes at 2000 rpm. The sample was then flipped and sheared for the second time at 2000 rpm for 2 minutes. Total amount of powders used in this sample is 15 g. The malleable sample was then turned into the film at room temperature. A freestanding film was formed at room temperature. This film was then calendered at 70° C. The ultimate tensile strength of these samples was measured using the ASTM D1708 method. The tensile bar was a dog bone, as described in ASTMD1708. The speed used for this experiment was 12.7 mm/min. The ultimate tensile strength was measured in a controlled environment, where the dew point was kept at −5° C. The samples were not conditioned before the tensile test. Through plane resistivity of these samples were measured. For through-plane resistivity, the sample was punched to 1″ diameter circles and was placed between two gold plated sheets. The resistance between the two plates, at different applied force, is measured using a Yoogawa resistance meter. The Ultimate tensile strength and resistivity of these samples are reported in Table 6. FIG. 4 shows the picture of film of this example shows that this film passes the 2 mm mandrel test.

### Example 15 Making LFP Films

LFP films were made by mixing LFP active material (YN-7, Hunan Yuneng New Energy Battery Material Ltd.), PTFE (601X, Chemours), Kynar761 (PVDF homopolymer), and graphite processing aid (KS6L, Imerys) in a weight ratio of 93, 2, 2, and 3%. A Thinky mixer (ARE310) mixer was used. First PVDF and LFP were mixed at 2000 rpm for 2 minutes. Then, KS6L processing aid was added, and this mixture was also mixed at 2000 rpm for 2 minutes. PTFE was added, and the mixture was mixed at 2000 rpm for 2 minutes. The mixing was repeated four times. After that the sample was sheared with mixing media, 4 beads of 10 mm and 3 beads of 12 mm, for 2 minutes at 2000 rpm. The sample was then flipped and sheared for the second time at 2000 rpm for 2 minutes. Total amount of powders used in this sample is 15 g. The malleable sample was then turned into the film at room temperature. A freestanding film was formed at room temperature. This film was then calendered at 70° C. The tensile strength of these samples was measured using the ASTM D1708 method. The tensile bar was a dog bone, as described in ASTMD1708. The speed used for this experiment was 12.7 mm/min. The ultimate tensile strength was measured in a controlled environment, where the dew point was kept at −5° C. The samples were not conditioned before the tensile test. Through plane resistivity of these samples were measured. For through-plane resistivity, the sample was punched to 1″ diameter circles and was placed between two gold plated sheets. The resistance between the two plates, at different applied force, is measured using a Yoogawa resistance meter. The Ultimate tensile strength and resistivity of these samples are reported in Table 6.

### Example 16 Making LFP Electrodes

The cathode film of example 14 was laminated on a carbon coated aluminum foil (Ensafe123, Armor) at 120° C. using a Hohsen roll mill. The electrode was dried to remove any residual moisture. A half-cell was made using this electrode. The cell is cycled between 2.4-4.1 V (vs Li/Li⁺) against lithium metal (thickness 250 μm). The electrolyte was 1 M LiPF₆ in EC/EMC with 5% FEC additive (all from Gotion) and a polyethylene separator (Celgard 2500) was used. Cycling results are presented in Table 7.

### Example 17 Making LFP Cathode Films

LFP films were made by mixing LFP active material (YN-7, Hunan Yuneng New Energy Battery Material Ltd.), PTFE (601X, Chemours), and graphite processing aid (KS6L, Imerys) in a weight ratio of 93, 4, and 3 wt %. A Thinky mixer (ARE310) mixer was used. First LFP and graphite processing aid were mixed at 2000 rpm for 2 minutes. Then, PTFE was added, and the mixture was mixed at 2000 rpm for 2 minutes. The mixing was repeated four times. After that the sample was sheared with mixing media, 4 beads of 10 mm and 3 beads of 12 mm, for 2 minutes at 2000 rpm. The sample was then flipped and sheared for the second time at 2000 rpm for 2 minutes. Total amount of powders used in this sample is 15 g. The sample was then turned into the film at room temperature The material was turned into a film at room temperature, and calendered using a horizontal calender at 70° C. The tensile strength of these samples was measured using the ASTM D1708 method. The tensile bar was a dog bone, as described in ASTMD1708. The speed used for this experiment was 12.7 mm/min. The ultimate tensile strength was measured in a controlled environment, where the dew point was kept at −5° C. The samples were not conditioned before the tensile test. Through plane resistivity of these samples were measured. For through-plane resistivity, the sample was punched to 1″ diameter circles and was placed between two gold plated sheets. The resistance between the two plates, at different applied force, is measured using a Yoogawa resistance meter. The Ultimate tensile strength and resistivity of these samples are reported in Table 6.

### Example 18 Making SCNT Films

Sulfur infused carbon nanotube (SCNT) films were made by mixing SCNT active material (Arkema), PTFE (601X, Chemours), functionalized PVDF of example 1, Super P, the first graphite processing aid (KS6L, Imerys), and the second graphite processing aid (GHDR15-4, Imerys) in a weight ratio of 70, 2, 3, 2, 3 and 20%. A Thinky mixer (ARE310) mixer was used. First PVDF, Super P, the first processing aid, and the second processing aid were mixed at 2000 rpm for 2 minutes. Then, KS6L processing aid was added, and this mixture was also mixed with mixing media (3 beads of 12 mm) at 1000 rpm for 90 seconds. Then PTFE was added, and the mixture was mixed at 1000 rpm for 90 seconds. The mixture was then mixed at 2000 rpm for 2 minutes. The mixing was repeated eight times. The beads were then removed and 70% SCNT was added and the sample was mixed twice at 2000 rpm for 2 minutes. The malleable sample was then turned into the film at room temperature. A freestanding film was formed at room temperature. This film was then calendered at 40° C. The tensile strength of these samples was measured using the ASTM D1708 method. The tensile bar was a dog bone, as described in ASTMD1708. The speed used for this experiment was 12.7 mm/min. The ultimate tensile strength was measured in a controlled environment, where the dew point was kept at −5° C. The samples were not conditioned before the tensile test. Through plane resistivity of these samples were measured. For through-plane resistivity, the sample was punched to 1″ diameter circles and was placed between two gold plated sheets. The resistance between the two plates, at different applied force, is measured using a Yoogawa resistance meter. The Ultimate tensile strength and resistivity of these samples are reported in table 8.

### Example 19 Making LMFP Films

LMFP films were made by mixing LMFP active material (LMFP64, Skyland), PTFE (601X, Chemours), functionalized PVDF of example 1, Super P, and graphite processing aid (KS6L, Imerys), in a weight ratio of 91, 2, 2, 2, and 3. A Thinky mixer (ARE310) mixer was used. First PVDF, and KS6L processing aid were mixed at 2000 rpm for 2 minutes. Then, Super P was added, and this mixture was also mixed at 2000 rpm for 2 minutes. AM was added to the first mixture and was dispersed by mixing at 2000 rpm for 2 minutes. PTFE was added, and the mixture was mixed at 2000 rpm for 2 minutes. The final high shear mixing was with mixing media, 4 beads of 10 mm and 3 beads of 12 mm, at 2000 rpm for 2 minutes. A freestanding film was formed at room temperature. This film was then calendered at 70° C. The tensile strength of these samples was measured using the ASTM D1708 method. The tensile bar was a dog bone, as described in ASTMD1708. The speed used for this experiment was 12.7 mm/min. The samples were processed at room temperature and the tensile strength was measured in a controlled environment, where the dew point was kept at −5° C. The samples were not conditioned before the tensile test. Through plane resistivity of these samples were measured. For through-plane resistivity, the sample was punched to 1″ diameter circles and was placed between two gold plated sheets. The resistance between the two plates, at different applied force, is measured using a Yoogawa resistance meter. The Ultimate tensile strength and resistivity of these samples are reported in Table 6.

### Example 20 Homopolymer PVDF-PTFE Mixture

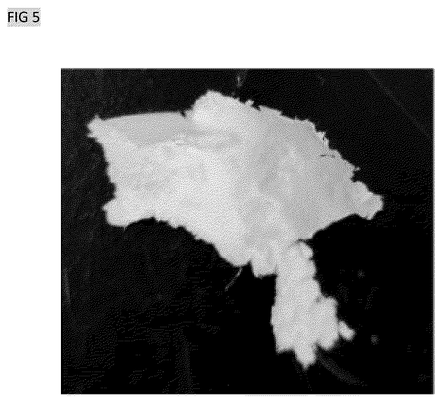

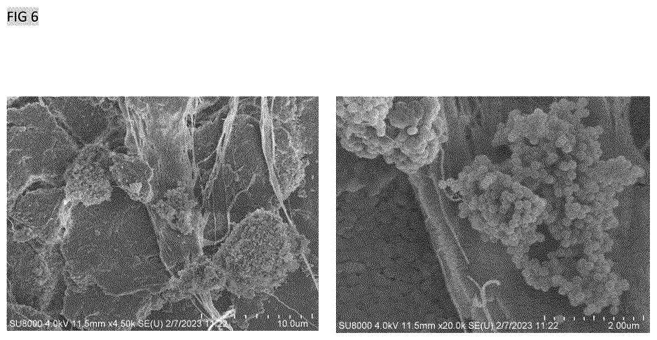

Kynar 741-PTFE mixture was made by shearing 3 g of Kynar 741 PVDF homopolymer and 1 g of PTFE powder at room temperature with total of 7 Zirconia beads of 6.5 mm, using a planetary mixer Thinky ARE-310. The powder was first mixed at 500 rpm for 1 minute, with 2 zirconia beads, followed by shearing at 2000 rpm for 2 minutes with total of 7 zirconia beads resulting in formation of PVDF-PTFE blend, FIG. 5. FIG. 6 is an SEM of Example 20 showing that the PVDF homopolymer (Kynar 741) did not form an alloy with the PTFE. The agglomerated PVDF particles can be seen in the SEM.

### Example 21 Making PVDF-PTFE Porous Mat

Kynar 761 PVDF-PTFE (PVDF/PTFE: 3/1 by weight) samples were made following the process of example 20. The samples were then pressed at six metric ton at a temperature of 20° C. for 10 minutes using a Carver Press and porous mats were fabricated. The tensile bar has a thickness of ˜1000 μm. Ultimate tensile strength of these mats was measured according to the ASTM D1708 method and the tensile at break were normalized to account for differences in porosities of these mats and reported in Table 1. Table 1 shows that the mats made from the alloy using functionalized PVDF of example 1 and of example 4, have higher tensile strength compared to the mat made using the Kynar 761 PVDF-PTFE blend.

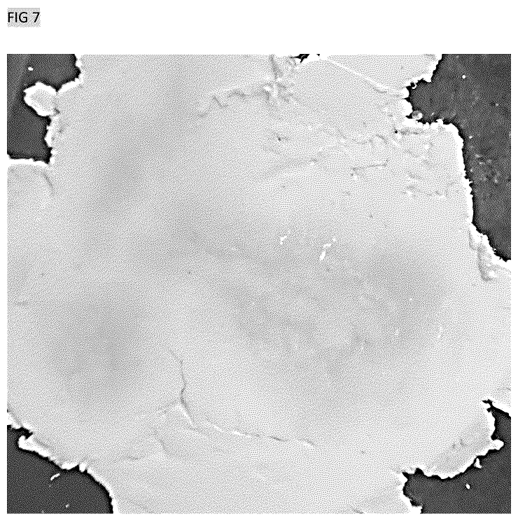

FIG. 7 shows the porous mat made from example 21. The material exhibits a non-homogeneous composition. As seen in the FIG. 7 the darker shade areas of the mat indicates areas to be of higher density (less porous) than the lighter shade or white areas which are more porous. This shows that the PVDF and PTFE did not form a uniform alloy.

TABLE 1
Ultimate tensile results of PVDF-PTFE porous mats

| | Ultimate Tensile |
|---|---|
| Sample | (kPa) ASTM D1708 |
| 761/PTFE | 830 |
| Example 6 Scaffold blend of | 1930 |
| PVDF of example 1 with PTFE | |
| Example 6 Scaffold blend of | 1280 |
| PVDF of example 4 with PTFE | |

### Example 22 FTIR of Pure PVDF and PVDF-PTFE

The FTIR spectra of Kynar 711, 761, and HSV900 powders, and porous mats of Kynar711-PTFE, 761-PTFE, and HSV900-PTFE, made using the process described in example 21, were measured and the amount of non-α phase for PVDF was calculated. For the analysis, the regions 837-840 cm⁻¹ (CH₂ and CF₂ vibrations) as containing high contribution from non-α and 763-765 cm⁻¹ (CF₂ and CCC vibrations) as containing mainly a contributions are selected. For each spectrum, the peak heights are determined (the two selected regions) and a ratio is calculated. The percentage of non-α phase is reported in Table 2. From this table we can conclude that the percentage of non-α phase of functionalized PVDF of example 1 and 4 is higher than 70%. The percentage of non-α phase increases by mixing PVDF with PTFE. Even after mixing with PTFE, the non-α phase is higher than 70% for the functionalized PVDF of example 1 and 4, while it is still lower than 70% for the nonfunctionalized PVDF-PTFE blend.

TABLE 2
FTIR of pure PVDF and PVDF/PTFE samples

| | $\frac{( non - alpha )}{( non - alpha ) + ( alpha )} ( \% )$ | |
|---|---|---|
| Sample | Pure | Sheared with 25% PTFE |
| Kynar ® 711 | 52 | 61 |
| Kynar ® HSV900 | 63 | 68 |
| Kynar ® 761 | 55 | 66 |
| PVDF of example 1 | 72 | 79 |
| PVDF of example 4 | 81 | 90 |

### Example 23 TGA of PVDF and PVDF-PTFE

Thermal degradation of Kynar 761, HSV900 powder and blend of Kynar761-PTFE and HSV900-PTFE, made using the process described in example 21, was evaluated by TGA. The decomposition temperature at 5% weight loss is reported in Table 3. The decomposition temperature corresponds to 5% weight loss of the initial mass, when the decomposition starts. Based on these results, the thermal degradation of Kynar 761 is higher than the PVDF of example 1 and example 4. The 5% weight loss temperature of Kynar 741 is higher than the functionalized PVDF of examples 1 and 4, even after shearing with PTFE.

TABLE 3
Thermal degradation of PVDF

5% weight loss temperature (° C.)

| Sample | Pure | Sheared with 25% PTFE |
|---|---|---|
| Kynar ® HSV900 | 445 | 432 |
| Kynar ® 761 | 441 | 436 |
| PVDF of example 4 | 412 | 420 |
| S5130 | 448 | 454 |

### Counter Example 5 Evaluating the Quality of the Film and Cohesion Between Particles

NMC811 films were made by mixing NMC811 active material (Ronbay), PTFE, functionalized PVDF of example 1, and conductive carbon (Super P, Imerys) in a weight ratio of 95, 1.5, 1.5, and 2%. A Thinky mixer (ARE310) mixer was used. First PVDF and NMC811 were mixed at 2000 rpm for 2 minutes. Then Super P was added, and the mixture was mixed at 2000 rpm for 2 minutes. To the second mixture KS6L processing aid was added, and this mixture was also mixed at 2000 rpm for 2 minutes. PTFE was added, and the mixture was mixed at 2000 rpm for 2 minutes. The mixing was repeated four times. After that the sample was sheared with mixing media, 4 beads of 10 mm and 3 beads of 12 mm, for 2 minutes at 2000 rpm. The sample was then flipped and sheared for the second time at 2000 rpm for 2 minutes. To avoid melting the polyethylene Thinky jar, ice bath was used, and the jar was cooled to 25-35° C. after each mix. Total amount of powders used in this sample is 30 g. The malleable sample was then turned into the film at room temperature. A freestanding film was formed at room temperature. To evaluate the cohesion of the particles and quality of the scaffold, the amount of loose powder was measured using a scotch tape. A scotch tape (A=area in cm²), (weight=m₁) was placed on the film. After passing the tape with a roller, the weight of scotch tape was measured (m₂) for the second time. The change in weight of the scotch tape (m₂-m₁) represents the amount of loose powder. The change in weight for this sample was measured to be 17 mg/cm², calculated using the following equation:

$$\frac{{m}_{2} - {m}_{1}}{A}$$

Based on these results, the increase in weight of scotch tape, representing the amount of loose powder in the cathode film of counter example 5 (no processing aid) is higher than example 12, where the processing aid was used in the cathode.

### Counter Example 6 Making LFP Cathode Films

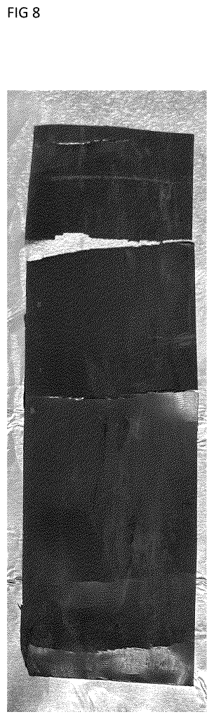

LFP films were made by mixing LFP active material (YN-7, Hunan Yuneng New Energy Battery Material Ltd.), PTFE (601X, Chemours), functionalized PVDF of example 1, and Super P conductive carbon (Imerys) in a weight ratio of 93, 2, 2, and 3 wt %. A Thinky mixer (ARE310) mixer was used. First PVDF and LFP were mixed at 2000 rpm for 2 minutes. Then, KS6L processing aid was added, and this mixture was also mixed at 2000 rpm for 2 minutes. PTFE was added, and the mixture was mixed at 2000 rpm for 2 minutes. The mixing was repeated four times. After that the sample was sheared with mixing media, 4 beads of 10 mm and 3 beads of 12 mm, for 2 minutes at 2000 rpm. The sample was then flipped and sheared for the second time at 2000 rpm for 2 minutes. Total amount of powders used in this sample is 15 g. The malleable sample was then turned into the film at room temperature The material was turned into a film at room temperature, and calendered to using a horizontal calender at 70° C. FIG. 8 shows the picture of this film and confirms that this film is not flexible and cannot be used as electrode. On the other hand, the film made using KS6L processing aid in example 14 is flexible and passes the Mandrel test (size: 2 mm).

TABLE 4
Ultimate tensile strength and volume resistivity results of NMC622, NMC811, NMC83 films

| | | | | | | Volume |
|---|---|---|---|---|---|---|
| | | Active material/conductive | | | Ultimate | resistivity |
| | Active | carbon/Processing | Thickness | | Tensile | at 97.7N |
| Example | material | additive/PVDF/PTFE (wt %) | (μm) | PVDF | (KPa) | (kΩ · cm) |
| Example | NMC622 | 94.5/2/0.5/1.5/1.5 | 150 | PVDF of | 790 | 1.6 |
| 10 | | | | example 1 | | |
| Example | NM811 | 94.5/2/0.5/1.5/1.5 | 145 | PVDF of | 900 | 2.6 |
| 9 | | | | example 1 | | |
| Example | NMC83 | 94.5/2/0.5/1.5/1.5 | 115 | PVDF of | 815 | 2.6 |
| 13 | | | | example 1 | | |

TABLE 5
Cycling results of NMC811 and NMC622 electrodes

| | | Active | | | Recovery at |
|---|---|---|---|---|---|
| Example/ | | material | | $\frac{Capacity at C / 2}{Capacity at C / 10} \times 100$ | C/10, |
| counter | Active | loading | FCE | | SOH |
| example | material | (mg/cm²) | (%) | (%) | (%) |
| Example 11 | NMC622 | 31 | 91 | 88 | 97 |
| Example 11 | NMC811 | 27 | 92 | 87 | 100 |

TABLE 6
Ultimate tensile strength and volume resistivity results of LFP and LMFP films

| | | | | | | Volume |
|---|---|---|---|---|---|---|
| | | Active material/conductive | | | Ultimate | resistivity |
| | Active | carbon/Processing | Thickness | | Tensile | at 97.7N |
| Example | material | additive/PVDF/PTFE (wt %) | (μm) | PVDF | (KPa) | (kΩ · cm) |
| Example | LFP | 93/0/3/2/2 | 175 | PVDF of | 1170 | 0.4 |
| 14 | | | | example 1 | | |
| Example | LFP | 93/0/3/2/2 | 175 | 761 | 965 | 0.8 |
| 15 | | | | | | |
| Example | LMFP | 91/2/3/2/2 | 205 | PVDF of | — | 0.5 |
| 19 | | | | example 1 | | |
| Example | LFP | 93/0/3/0/4 | 175 | — | 2190 | 1.0 |
| 17 | | | | | | |

TABLE 7
Cycling results of LFP electrodes

| Example/ counter | Active | Active material loading | FCE | $\frac{Capacity at C / 2}{Capacity at C / 10} \times 100$ | Recovery at C/10, SOH |
|---|---|---|---|---|---|
| example | Material | (mg/cm²) | (%) | (%) | (%) |
| Example 16 | LFP | 23 | 99 | 92 | 98 |
| Example 16 | LFP | 31 | 99 | 90 | 98 |
| Example 16 | LFP | 47 | 99 | 82 | 98 |

TABLE 8
Ultimate tensile strength and volume resistivity results of CNT films

| | | Active | | | |
|---|---|---|---|---|---|
| | | material/conductive | | | Volume |
| Example/ | | carbon/Processing | | Ultimate | resistivity |
| counter | Active | additive/PVDF/PTFE | | Tensile | at 97.7N |
| example | material | (wt %) | PVDF | (KPa) | (Ω · cm) |
| Example 18 | SCNT | 70/2/23/3/2 | PVDF of | 390 | 5 |
| | | | example 1 | | |

1. A cathode film comprising: a processing aid, cathode active material, optionally a conductive carbon, and a fluoropolymer binder comprising PTFE, and wherein the cathode is free of solvent residue, and wherein the total binder amount is from 0.5 wt % to 10 wt % of the cathode film.

2. The cathode film of claim 1, further comprising PVDF as a component of the binder wherein the weight ratio of PVDF to PTFE in the cathode is 10:90 to 95:5

3. The cathode film of claim 1, wherein the processing aid has an ID/IG of less than 1.6.

4. The cathode film of claim 1, wherein the processing aid is a graphite-based processing aid.

5. The cathode film of claim 1, wherein the processing aid is selected from the group consisting of graphite powder, graphene, nano graphite, furnace black, acetylene black, carbon nanotubes (CNT), carbon nanofibers (CNF), fine graphite powder, vapor deposited graphite fibers, Ketjen carbon black and combinations thereof.

6. The cathode film of claim 1, wherein the processing aid has a number average particle size of less than 5 microns.

7. The cathode film of claim 1, wherein the processing aid is a flaked graphite having a number average particle size of less than 4.0 micrometers

8. The cathode film of claim 1, wherein the amount of processing aid is from 0.1 to 20 wt % based on the weight of the cathode film.

9. The cathode film of claim 2, wherein the PVDF is a homopolymer or vinylidene fluoride copolymer.

10. The electrode of claim 2, wherein the PVDF is a functionalized PVDF comprising a functional group.

11. The cathode film of claim 10, wherein the functional group is selected from the group consisting of a carboxylic group or salt or ester thereof, a phosphate, a sulfonate or a combination thereof.

12. The cathode film of claim 10, wherein the fluoropolymer binder comprising the PTFE and the functionalized PVDF is in the form of a scaffold.

13. The cathode film of claim 1, wherein the cathode film is freestanding.

14. The cathode film of claim 1, wherein the amount of fluoropolymer binder in the cathode film is from 0.5 weight % to 6 weight % based on weight of the cathode film.

15. The cathode film of claim 1, wherein the cathode film contains conductive carbon.

16. An energy storage device comprising the cathode film of claim 1, wherein the energy storage device is selected from the group consisting of a lithium-ion battery, a sodium-ion battery and a lithium sulfur battery.

17. A method of fabricating a cathode film of an energy storage device, comprising:
a) combining a processing aid, cathode active material, optionally conductive carbon, and PVDF to form a first mixture
b) adding PTFE to the first mixture to form a second mixture; and
c) subjecting the second mixture to a shearing process to form a dry cathode forming mixture comprising PVDF and PTFE; wherein no liquid is used in the process.

18. The method of claim 17, wherein the processing aid is selected from the group consisting of graphite powder, graphene, nano graphite, furnace black, acetylene black, carbon nanotubes (CNT), carbon nanofibers (CNF), fine graphite powder, vapor deposited graphite fibers, Ketjen carbon black and combinations thereof.

19. The method of claim 17, wherein the processing aid has a number average particle size of less than 5.0 micrometers.

20. The method of claim 17, wherein the amount of processing aid is from 0.1 to 20 wt % based on the weight of the cathode film.

21. The method of claim 17, wherein combining further comprises combining a conductive carbon with the active material and the PVDF to form the first mixture.
